(19) United States
(12) Patent Application Publication
(10) Pub. No.: US 2014/0046804 A1
(43) Pub. Date: Feb. 13, 2014

(54) CUSTOMIZING ONLINE AUTOMOTIVE VEHICLE SEARCHES

(71) Applicant: Mojo Motors, Inc., New York, NY (US)

(72) Inventors: Paul Nadjarian, New York, NY (US); Tae Oh, Brooklyn, NY (US); Daniel Harman, Brooklyn, NY (US); Patrick Brix, Long Beach, NY (US); Olawale Oladunni, Brooklyn, NY (US)

(73) Assignee: Mojo Motors, Inc., New York, NY (US)

(21) Appl. No.: 14/057,466

(22) Filed: Oct. 18, 2013

Related U.S. Application Data
(60) Provisional application No. 61/716,964, filed on Oct. 22, 2012.

(51) Int. Cl. G06Q 30/06

(52) U.S. Cl. CPC G06Q 30/0625
USPC 705/26.62

(57) ABSTRACT

A method for providing notifications related to a vehicle to the consumer, comprising receiving a plurality of activities of a user on a webpage of a web site posting of a vehicle, determining an interest level of the user for the web site posting of the vehicle in view of the plurality of activities of the user, receiving an indication of a change of a status of the web site posting of the vehicle, and providing to the user a notification of the change of the status of the web site posting of the vehicle in view of the interest level of the user, and in response to the indication of the change of the status of the web site posting of the vehicle.

### CROSS REFERENCE TO RELATED APPLICATION

The present application claims the benefit of U.S. Provisional Patent Application Ser. No. 61/716,964, titled “System and Method for Customizing Online Automotive Vehicle Searches,” filed on Oct. 22, 2012, the entire contents of which are herein incorporated by reference.

### TECHNICAL FIELD

The present disclosure relates generally to systems and methods for customizing online automotive vehicle searches and, more particularly, to systems and methods for ongoing tracking of changes in vehicle status and notification to the consumer of such changes.

### BACKGROUND

Online automotive vehicle shopping facilities (e.g., vehix.com, cars.com, and eBay motors) provide consumers with the ability to research and even purchase vehicles, without the hassle of having to travel to each dealer in person looking for the specific vehicle that suits the consumers' needs.

Vehicle dealers typically set a high price for an automobile and then, over time, periodically and systematically lower the price of the vehicle until it is sold. However, if a consumer is searching for a particular type of vehicle and they want to monitor the status of the vehicle, (e.g., to check if there has been a drop in price), the consumer may have to continuously log back on to whichever website they were visiting, and in some cases perform their search query again, to determine whether their desired vehicle has changed in price.

This can result in the consumer missing out on a great value if someone else purchases the vehicle before the consumer is even aware that there has been a price drop and afforded a chance to place a bid on the vehicle.

Thus, there is a need for an improved method and system for customizing online automotive searches, and for providing a notification to the consumer when there has been a change in the status of a desired vehicle.

### SUMMARY

The present disclosure relates to methods and systems for customized online vehicle searches which allow for providing notifications to the consumer when there has been a status change on a selected vehicle.

According to embodiments of the present disclosure, a method for providing notifications related to a vehicle to the consumer, comprising determining an interest level of a user for a web site posting of a vehicle, receiving an indication of a change of a status of the web site posting of the vehicle, and providing to the user a notification of the change of the status of the web site posting of the vehicle in view of the interest level of the user, and in response to the indication of the change of the status of the web site posting of the vehicle.

According to an embodiment, a method is disclosed for receiving a plurality of activities of the user on a webpage of the web site posting of the vehicle, and determining if the plurality of activities of the user on the webpage meets a predetermined threshold.

In another embodiment, a method is disclosed for providing to the user the notification of the change of the status of the web site posting of the vehicle in response to a determination that the plurality of activities of the user on the webpage meets the predetermined threshold.

In another embodiments, a method is disclosed for providing notifications related to a vehicle to the consumer comprising receiving a request for a web site membership from the user after the user has viewed a web site posting of the vehicle, and providing to the user, notifications of the change of the status of the web site posting of the vehicle in response to the request for the web site membership from the user.

For the purposes of this disclosure, the terms “user” and “consumer” are used interchangeably.

As used herein, the term “vehicle” is meant to include, but is not limited to, e.g., cars, trucks, motorcycles, boats, etc.

As used herein, the terms “activity”, “activities”, and “actions” are used interchangeably and are intended to mean an act or an interaction that a user consciously performs while interfacing with the systems and methods for customized online vehicle searches which allow for providing notifications to the consumer when there has been a status change on a selected vehicle.

### BRIEF DESCRIPTION OF THE DRAWINGS

The present disclosure will be more readily understood from the detailed description of exemplary embodiments presented below considered in conjunction with the attached drawings, of which:

FIG. 1 depicts a flowchart of an embodiment using the method of the present disclosure.

FIG. 2 depicts a flowchart of another embodiment using the method of the present disclosure.

FIG. 3 depicts a sample webpage in accordance with an embodiment of the present disclosure.

FIG. 4 depicts a sample webpage in accordance with an embodiment of the present disclosure.

FIG. 5 depicts a sample notification in accordance with an embodiment of the present disclosure.

FIG. 6 depicts a sample webpage in accordance with an embodiment of the present disclosure.

FIG. 7 depicts a representation of a system in the exemplary form of a computer system for use with the present disclosure.

It is to be understood that the attached drawings are for purposes of illustrating the concepts of the disclosure.

### DETAILED DESCRIPTION

The present disclosure provides for methods and systems which allow a user to receive notifications regarding the status of a vehicle. The “status” of the vehicle may include, e.g., the price, changes in an attribute of the vehicle (e.g., new tires were recently installed on the vehicle, the exhaust system was recently replaced), whether the vehicle is sold, the location of the vehicle, etc., and any combination thereof. Notifications may be displayed on a cellular phone, tablet, lap top, PC, etc., and may be sent to the user via, e.g., e-mail, text message, Twitter™, application notification, etc.

In an embodiment, the methods and systems of the present disclosure can be applied to items that are for sale other than a vehicle. The methods and systems as discussed within the present disclosure allows a user to receive notifications regarding the status of, for example, a house, real property, furniture, clothing, computers, appliances, livestock, pets, or any other item or service that can be purchased.

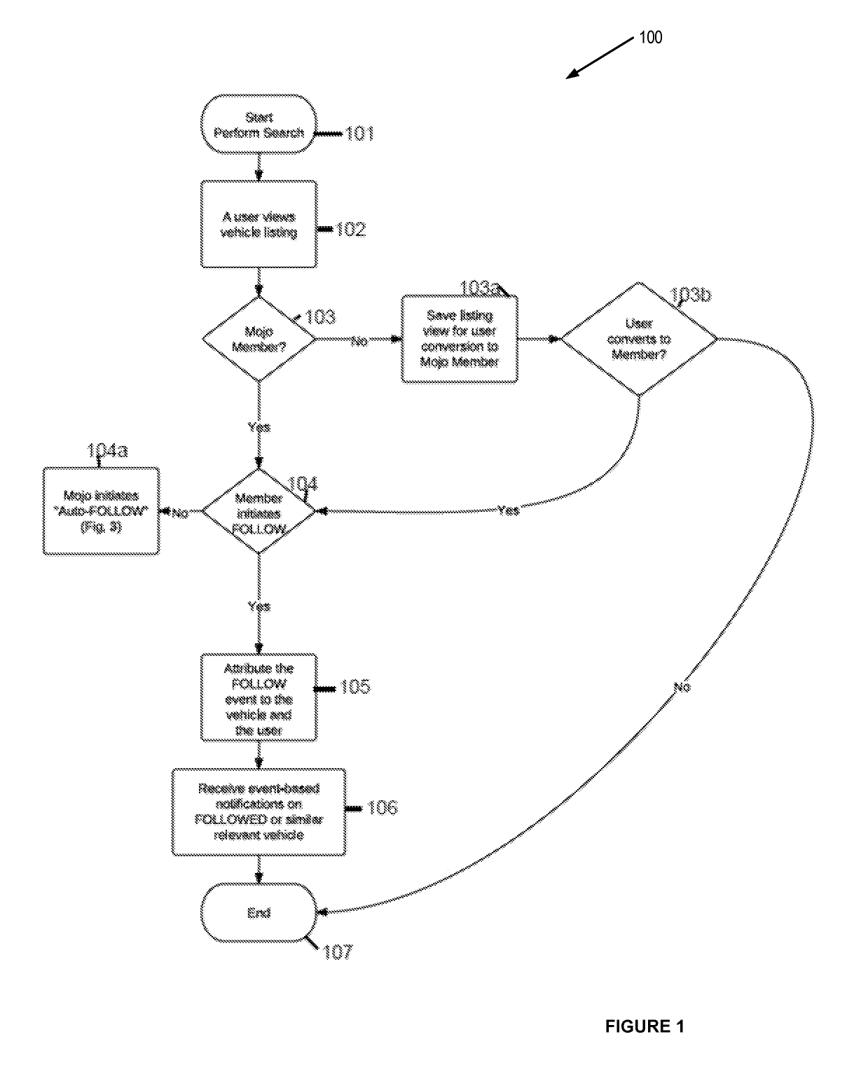

FIG. 1 depicts a flowchart of an embodiment using a method 100 of the present disclosure. The method 100 may be performed by processing logic that may comprise hardware (circuitry, dedicated logic, etc.), software (such as is run on a general purpose computing system or a dedicated machine), firmware (embedded software), or any combination thereof.

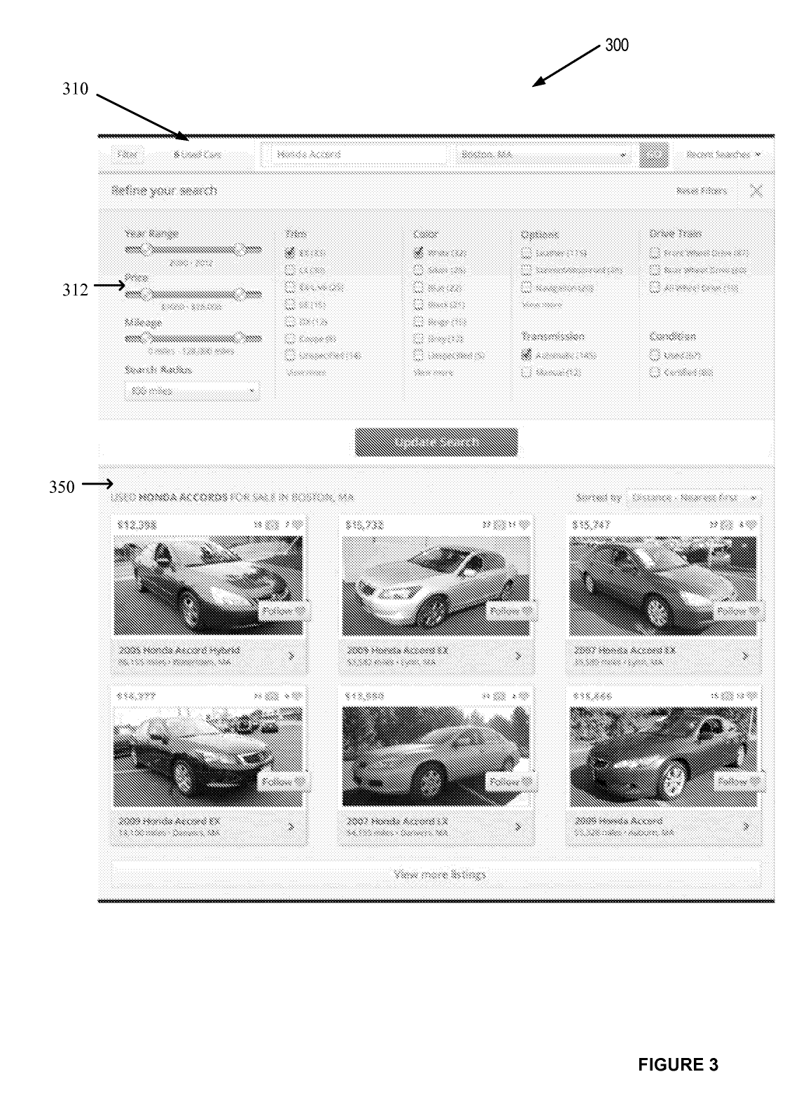

Referring to FIG. 1 at block 101, the method 100 starts to perform a search on a provider website in view of the receipt of a user's particular desired features in a vehicle. Examples of such features can include, but are not limited to, the manufacturer or make of the vehicle, the model type, the year of manufacture, mileage, location, and color of the specific vehicle. Other features can include, but are not limited to, options such as leather or cloth interior, whether or not the vehicle has a sunroof, the type of transmission, the type of drive train, and the condition of the desired vehicle. An example of a search webpage is shown at the top of FIG. 3. At block 102, a user views vehicle listings or advertisements (i.e., “web site postings”) of certain vehicles, based on the search results. Such vehicles include details that match the desired features. An example of resultant search postings, listings or advertisements is shown at the bottom of FIG. 3.

At block 103, a determination is made as to whether or not the user is a registered member of the provider website. At block 104, if the user is a registered member of the provider website, a selection of a “follow” option can be received from the user in order for the user to “follow” the web site posting of the selected vehicle. As used herein, the term “follow” is intended to mean that a notification is sent to the user upon receiving an indication of a change in a status of the web site posting of the selected vehicle. A change in the status can include, for example, a change in the price of the vehicle, a change in location of the vehicle, the vehicle is no longer available, the vehicle has recently received certain upgrades (e.g., new tires, etc.), complimentary services have recently been included with the vehicle, or the like.

At block 105, the selected or “followed” vehicle is matched to the user and as a result, the user is provided with status updates upon a change in the status of the web site posting of the selected vehicle. At block 106, the user is provided with a notification of a change in the status of the web site posting of the selected vehicle.

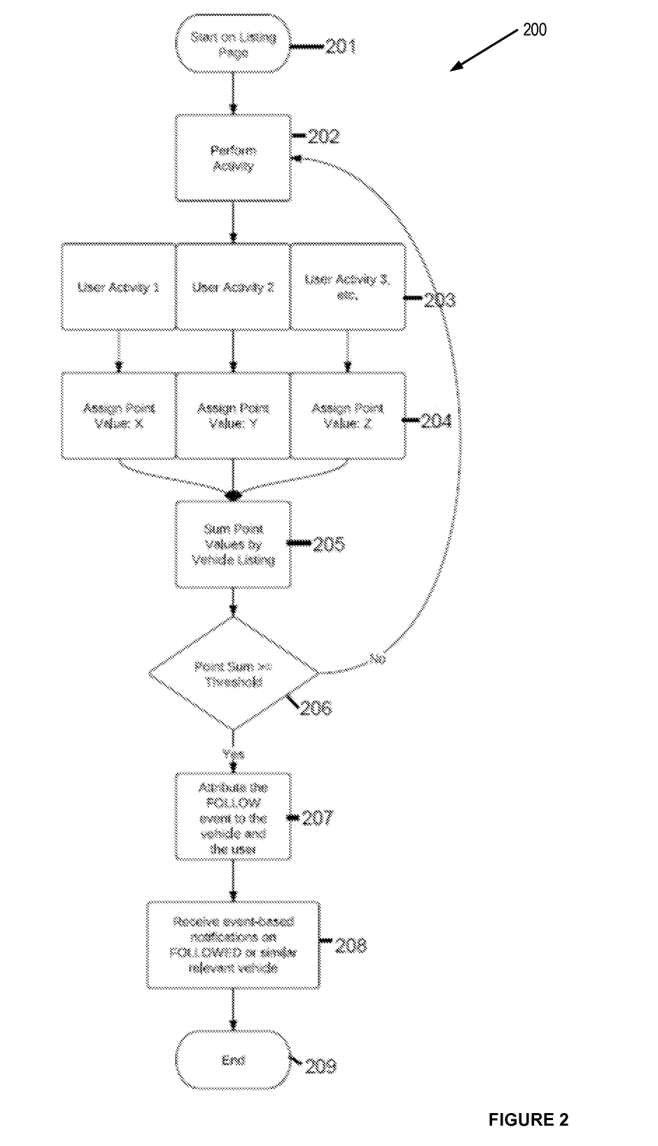

Reverting back to block 103, in the event that the user is a registered member of the provider website but does not elect the “follow” option, then at block 103a the user's activity on the website can be tracked to determine if the user should be provided status updates on a particular vehicle, as described in further detail below in reference to FIG. 2 (“autofollow”). As used herein, the term “autofollow” means that in the absence of the user explicitly selecting the “follow” button, the system can apply the “follow” features to a vehicle based on the user's behavior.

If the user is not a registered member of the provider website, then the web site posting of a selected vehicle that the user was viewing is stored in memory so that when the user registers with the website, the stored vehicle is “autofollowed”. At block 103b, upon the user becoming a registered member of the provider website, the method proceeds to block 104 where vehicles are “followed” by the user. In certain embodiments, at block 104a, the vehicle(s) associated with the webpage(s) that a non-registered user was viewing upon becoming a registered member are autofollowed, (i.e., without the user expressly electing to follow the vehicle(s)).

FIG. 2 depicts a flowchart of another embodiment using a method 200 of the present disclosure. The method 200 may be performed by processing logic that may comprise hardware (circuitry, dedicated logic, etc.), software (such as is run on a general purpose computing system or a dedicated machine), firmware (embedded software), or any combination thereof.

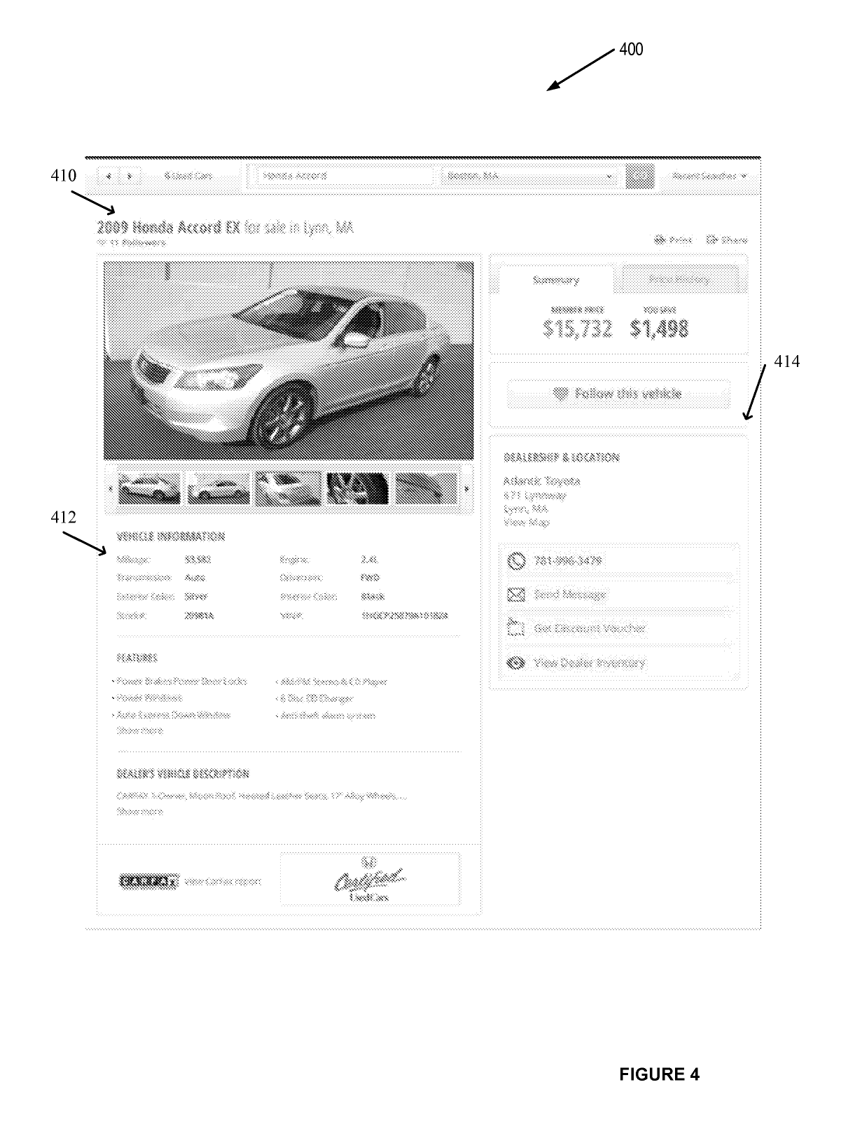

At block 201, the method 200 starts on a listing page that includes listings or advertisements (i.e., “web site postings”) of certain vehicles are provided to the user, based on the search results. At block 202, the method 200 performs activities that are tracked, such as selecting a web site posting of a vehicle for a more detailed description, as shown in FIG. 4. Other examples of user activities include instances where the user repeatedly clicks on a certain vehicle several times, or the user views a certain number of pictures of the vehicle, or the user contacts the dealer, or the user views the Carfax™ report. At block 203, the user's further detailed activities are tracked, e.g., the user clicks on the summary of the vehicle, the price history of the vehicle, requests a discount voucher, sends an e-mail to the dealer through the website, etc.

At block 204, a value or relevancy score is assigned to each respective activity or action, and in certain embodiments, the value may also be weighted. For example, the actions of “following” a vehicle and clicking onto a vehicle's specific link may both have, e.g., an assigned value of 2. However, the “follow” action may be weighted so that when determining which particular notifications to send to the user, as described further below, the “follow” action may end up having a higher value.

At block 205, the sum of the values of the user's activities relating to a particular vehicle are calculated, and then at block 206, the sum of the activity values is used to compare against a predetermined threshold amount. In an embodiment, the sum of the activities values is indicative of a user's interest level for a web site posting of a certain vehicle. An exemplary algorithm would be, e.g., ((Xₐ)*(Yₐ)*(Zₐ))+((X_{b})*(Y_{b})*(Z_{b})), where each respective subscript is associated with a particular action by the user. For example, X is the number of times the action is performed, Y is the assigned value of the action, and Z is the weighted value of the action.

In an non-limiting example, such actions as identified by subscripts “ₐ” and “_{b}” as noted above include clicking on a certain vehicle to view additional details that are related to that vehicle, clicking on the Carfax™ report or a vehicle history report to check the accident and maintenance history of that vehicle, clicking on the price history to check the changes in the price of that vehicle, send a message to the dealer about the vehicle, and the like.

The following is an example for determining that the sum of the values of the activities meets or exceeds the predetermined threshold. For example, when a certain member views a vehicle the respective score can be 5 and the respective weight can be 2/10. When the member shares the vehicle with a friend (via, e.g., share link), this activity has a score of 8 and has a weight of 4/10. Later, (e.g., the next day) the same member clicks on the same vehicle in an email alert to view the vehicle, which has a score of 6 and has a weight 3/10). Further suppose that the predetermined threshold is 5. All three of these activity events are scored and weighted differently, but in combination the accumulated behavior score (1+3.2+1.8=6) would surpass the threshold of interest needed to initiate an auto-follow of the vehicle.

Upon determining that the sum of the values of the activities meets or exceed the predetermined threshold, the listing or web site posting of the vehicle is “autofollowed”. In an embodiment, a determination is made that the web site posting of the vehicle should be followed for the user without receiving an express indication from the user to follow the listing or advertisement. In an embodiment, at block 208, notifications are provided to the user when there is a status change in the posting the vehicle, for example, upon an occurrence of a reduction in the price of the vehicle, or when the vehicle has been sold and is no longer available, or when the location of the vehicle has been changed, as discussed above.

The following is an example of an embodiment of the present disclosure. A consumer (not a registered user of the provider website) is looking to purchase a used 2007 or 2008 four door sedan from a Japanese manufacturer. The consumer conducts a search on the provider website using, for example the manufacturer (i.e., “make”), model, preferred year of manufacture, and within a certain geographical range of the zip code of the consumer. The provider website displays a listings page of vehicles that match the consumer's search criteria. In an embodiment, the system can display the listings in a certain order that is customizable by the consumer (e.g., sort by price, popularity in terms of most followed, nearest to location, mileage, etc.). The consumer then selects a particular vehicle of interest from the listing (vehicle A) for more details.

Upon reaching the selected vehicle's webpage, the consumer registers to become a member of the website. The system stores vehicle A in its memory and associates it with the consumer. The consumer returns to the listings page and selects the follow option on two other vehicles (vehicle B and vehicle C). The system monitors the status of vehicles A (auto-selected), B and C (manually selected). When the system detects a price decrease in vehicles A, B, or C, the system sends the consumer an e-mail notifying them of the price decrease.

FIG. 3 depicts a sample webpage 300 in accordance with an embodiment of the present disclosure. The webpage 300 includes an input area 310 in which the user inputs certain search details such as the manufacture of a vehicle (e.g., Honda), a model of the vehicle (e.g., Accord), a location (e.g., Boston, Mass.), and further details 312 such as a range in the year of manufacture of the desired vehicle, a price range, a mileage range, and other search criteria such as trim, color, luxury feature options, type of transmission, type of drive train, and condition of the vehicle. The input area includes an “update search” button for the user to initiate the search in view of the selected desired options.

In response to the search, the system provides a listing or a search result display area 350 of an inventory of vehicles that fall within the user's selected search criteria. The search result display area 350 shows multiple images of vehicles (in this example, the search result display area 350 shows images of six vehicles that fall within the selected criteria. Each of the displayed vehicles includes a “follow” button such that if the user is interested in following such vehicle (e.g., to receive a notification of a reduction in price), the user simply selects or “clicks on” the respective “follow” button.

In an embodiment, the search result display area 350 includes a “view more listings” button. The user chooses to view more listings of vehicles that fall within the search criteria by clicking on the “view more listings” button. When the “view more listings” button is selected by the user, the system displays additional images of vehicles that fall within the desired criteria.

In an embodiment, the search result display area 350 prioritizes and presents the search results in view of the user's behavior. For example, if the user does not outwardly select “silver” as a desired color when searching for a vehicle, but the majority of the vehicles viewed by the user are silver color, the relevancy calculation as discussed above may be used to prioritize the order of the search result display such that the silver colored cars are presented first.

In another embodiment, the search result display area 350 prioritizes and presents the search results in view of a trending metric. For example, two or more vehicles may have the same number of “follows”. However, if the first vehicle has accumulated 25 “follows” in 30 days (i.e., 25 users have “follow” or “autofollow” attributed to the first vehicle in 30 days) whereas the second vehicle has accumulated 25 “follows” in 3 days, the second vehicle may be deemed to be “hotter” or more desirable than the first vehicle. In this example, the display is prioritized to show the “hotter” first vehicle before it shows the less desirable second vehicle.

FIG. 4 depicts a sample webpage 400 in accordance with an embodiment of the present disclosure. The webpage 400 is an example that shows the details of the vehicle that was selected from the display area 350 of FIG. 3. The webpage 400 includes a general vehicle information area 410, a detailed vehicle information area 412, and a user action area 414.

The general vehicle information area 410 includes general information about the vehicle, such as the year of manufacture, the manufacturer, the model type, location, and price of the vehicle (in this example, 2009 Honda Accord EX in Lynn, Mass., $15,732). The general vehicle information area 410 includes several pictures of the vehicle for the user to click on and observe. The detailed vehicle information area 412 includes specific information about the vehicle, such as the mileage, transmission type, color, stock #, engine type, drive train, interior color, vehicle identification number (VIN), features, and a description.

If the user is interested in possibly purchasing this vehicle, the user action area 414 includes activities such as “follow this vehicle” in which, as discussed above, the system sends a notification of a change in the status of the vehicle (e.g., a reduction in price) to the user. The user action area 414 also includes buttons to simply for the user the ability, by pressing on the respective button, to call the dealership to inquire about the vehicle, to send a message to the dealer, to get a voucher from the dealer for potential further discounts or benefits (e.g., free oil change, free tune-up, etc.), to view the dealer inventory, and/or to view the Carfax™ report.

As discussed above, based on certain combinations of user activities such as, for example, the user repeatedly clicks on a certain vehicle several times, or the user views a certain number of pictures of the vehicle, or the user contacts the dealer, or the user views the Carfax™ report, then the totality of such behavior can be interpreted that the user has attained a sufficient level of interest in this vehicle such that the user would welcome receiving notifications of changes in the status of the vehicle (e.g., a reduction in price). In an embodiment, a determination is made that the user will “autofollow” such vehicle based on the user's actions or activities.

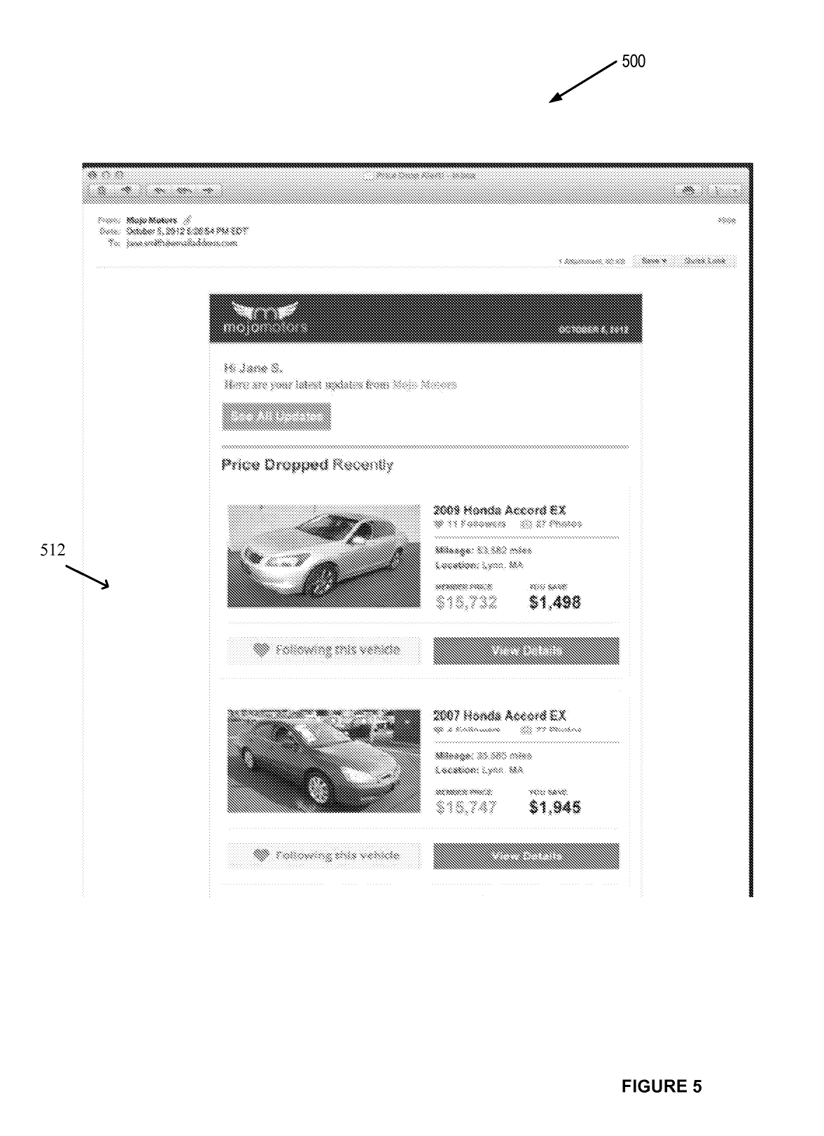

FIG. 5 depicts a sample notification 500 in accordance with an embodiment of the present disclosure. As discussed above, a notification may be displayed on a user's cellular phone, tablet, lap top, PC, etc., and may be sent to the user via, e.g., e-mail, text message, Twitter™, application notification, etc. An example of a notification that is sent to a user is via e-mail is shown in FIG. 5.

In an embodiment, the notification 500 includes certain information in the email 512 such as recent price reductions for vehicles that the user is “following”. In this example, the email 512 shows price reductions for two vehicles that the user is following.

In an embodiment, the notification 500 is prioritized such that the order of the vehicles is reflective of the user's behavior. Using the example discussed above, if the user does not outwardly select “silver” as a desired color when searching for a vehicle, but the majority of the vehicles viewed by the user are silver, the relevancy calculation as discussed above may be used to prioritize the order of the vehicles that are presented in the notification such that the silver colored cars are presented first.

In an embodiment, the notification 500 includes images and information for vehicles that are determined by the system using the relevancy calculations described above. For example, the system determines that the user is interested in a certain type of vehicle. The system matches the user's desired features to a certain vehicle that has such desired features and includes this vehicle in the notification 500 to the user. In an embodiment, a determination is made that the user will “autofollow” a vehicle that the user has not yet viewed, based on the user's actions or activities.

In certain embodiments, a registered member is provided with a summary of his or her activities on the website. The summary may include, e.g., a listing of the vehicles that the user is following, information regarding status changes on the followed vehicles, recent listings viewed by the user, information on status changes on a vehicle that is related/similar to those being followed, etc. The system may also provide information to inform users of how many other users are following a particular vehicle.

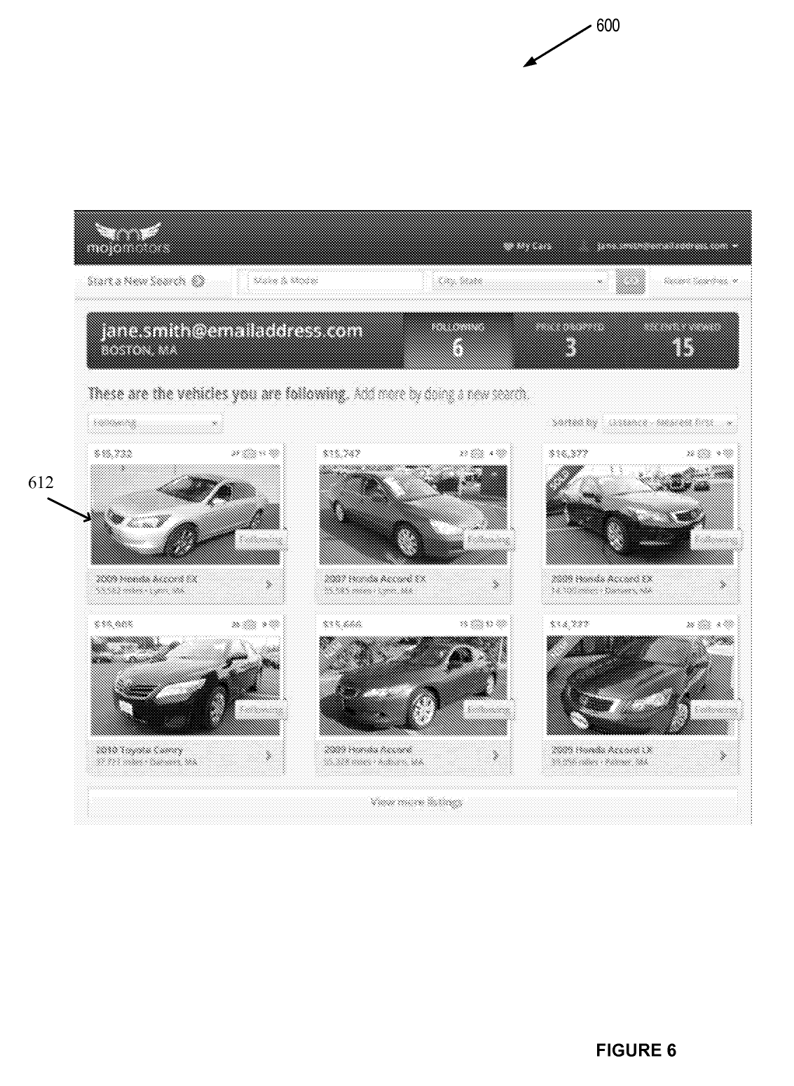

FIG. 6 depicts a sample webpage 600 in accordance with an embodiment of the present disclosure. The sample webpage 600 shows an example in which a registered member selects a tab to display information relating to their followed vehicles, which vehicles had a price decrease, and which vehicles were recently viewed.

As mentioned above, the notifications are provided to a user regarding certain vehicles that are similar to a particular vehicle the user is following. In such an embodiment, particular details regarding a followed vehicle are tracked, such as, e.g., manufacturer (i.e., “make”), model, year, mileage, location, color, etc., and search the system database for other vehicles meeting, or closely related to, the search criteria. In this manner, the user is provided with notification on a vehicle the system determines may be of interest to the user, without the specific request of the user to “follow” the vehicle.

In certain other embodiments, the present disclosure may be incorporated into a third party website. In such an embodiment, a “follow” selection appears for vehicles on a third party's website. The user visiting the third party website can follow a selected vehicle in a similar fashion as the user would on the provider website. If the user is a member of the provider website, the user may be asked for their login information on the third party website in order to have their activity tracked, including their “follow” selections. If the user is not a member of the provider website, the user may have the opportunity to register with the provider website by accessing a link to the provider website through the third party website. In certain embodiments, the follow option on the third party website also informs users, when viewing the third party website, how many other registered members are following a particular vehicle. The provider website can also be updated to reflect the changes in the user profile (e.g., the user's followed vehicles) as well as changes in the vehicles on the website (e.g., the number of followers for each vehicle).

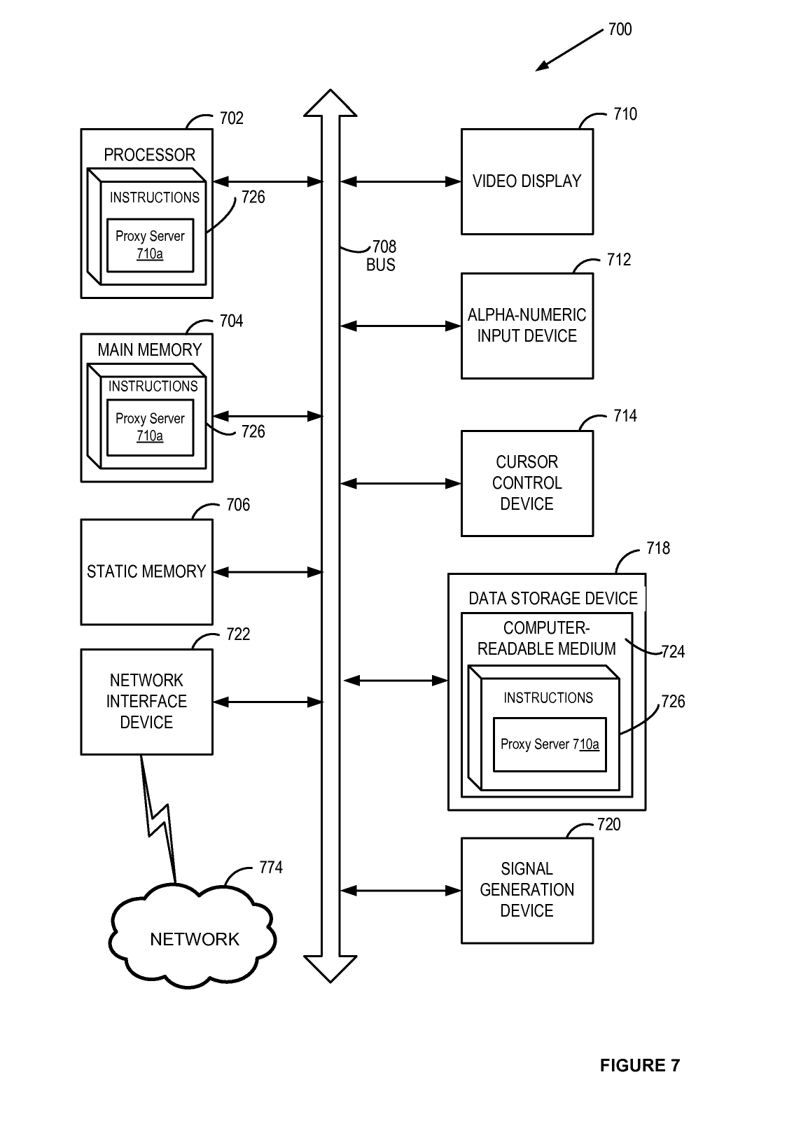

FIG. 7 illustrates a diagrammatic representation of a machine in the exemplary form of a computer system 700 within which a set of instructions, for causing the machine to perform any one or more of the methodologies discussed herein, may be executed. In alternative embodiments, the machine may be connected (e.g., networked) to other machines in a LAN, an intranet, an extranet, or the Internet. The machine may operate in the capacity of a server or a client machine in client-server network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a server, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The exemplary computer system 700 includes a processing device (processor) 702, a main memory 704 (e.g., read-only memory (ROM), flash memory, dynamic random access memory (DRAM) such as synchronous DRAM (SDRAM) or Rambus DRAM (RDRAM), etc.), a static memory 706 (e.g., flash memory, static random access memory (SRAM), etc.), and a data storage device 718, which communicate with each other via a bus 708.

Processor 702 represents one or more general-purpose processing devices such as a microprocessor, central processing unit, or the like. More particularly, the processor 702 may be a complex instruction set computing (CISC) microprocessor, reduced instruction set computing (RISC) microprocessor, very long instruction word (VLIW) microprocessor, or a processor implementing other instruction sets or processors implementing a combination of instruction sets. The processor 702 may also be one or more special-purpose processing devices such as an application specific integrated circuit (ASIC), a field programmable gate array (FPGA), a digital signal processor (DSP), network processor, or the like. The processor 702 is configured to execute instructions 726 for performing the operations and steps discussed herein.

The computer system 700 may further include a network interface device 722. The computer system 700 also may include a video display unit 710 (e.g., a liquid crystal display (LCD) or a cathode ray tube (CRT)), an alphanumeric input device 712 (e.g., a keyboard), a cursor control device 714 (e.g., a mouse), and a signal generation device 720 (e.g., a speaker).

The data storage device 718 may include a non-transitory computer-readable storage medium 724 on which is stored one or more sets of instructions 726 (e.g., software) embodying any one or more of the methodologies or functions described herein. The instructions 726 may also reside, completely or at least partially, within the main memory 704 and/or within the processor 702 during execution thereof by the computer system 700, the main memory 704 and the processor 702 also constituting computer-readable storage media. The instructions 726 may further be transmitted or received over a network 774 via the network interface device 722.

In one embodiment, the instructions 726 include instructions for implementing a SMS-enabled OpenADR 2.0 Proxy server 710a and/or a software library containing methods that call such a proxy server 710a. While the non-transitory computer-readable storage medium 724 is shown in an exemplary embodiment to be a single medium, the term “computer-readable storage medium” should be taken to include a single medium or multiple media (e.g., a centralized or distributed database, and/or associated caches and servers) that store the one or more sets of instructions. The term “computer-readable storage medium” shall also be taken to include any medium that is capable of storing, encoding or carrying a set of instructions for execution by the machine and that cause the machine to perform any one or more of the methodologies of the present disclosure. The term “non-transitory computer-readable storage medium” shall accordingly be taken to include, but not be limited to, solid-state memories, optical media, and magnetic media.

In the above description, numerous details are set forth. It will be apparent, however, to one of ordinary skill in the art having the benefit of this disclosure, that the present disclosure may be practiced without these specific details. In some instances, well-known structures and devices are shown in block diagram form, rather than in detail, in order to avoid obscuring the present disclosure.

Some portions of the detailed description that follow are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “calculating”, “assigning”, “determining”, “receiving,” “providing” or the like, refer to the actions and processes of a computer system, or similar electronic computing device, that manipulates and transforms data represented as physical (e.g., electronic) quantities within the computer system's registers and memories into other data similarly represented as physical quantities within the computer system memories or registers or other such information storage, transmission or display devices.

The present disclosure also relates to an apparatus for performing the operations herein. This apparatus may be specially constructed for the required purposes, or it may comprise a general purpose computer selectively activated or reconfigured by a computer program stored in the computer. Such a computer program may be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions.

In addition, while embodiments of the disclosure have been described by way of having certain steps, embodiments of the disclosure can also include methods whereby certain of the steps are omitted, performed in a different sequence than that of the provided examples, certain of the steps are performed concurrently, and/or certain of the steps are performed more than once. Further, the steps of the embodiments of the disclosure may be automated, performed manually, or be a combination of both automated and manual steps.

It is to be understood that the exemplary embodiments are merely illustrative of the disclosure and that many variations of the above-described embodiments can be devised by one skilled in the art without departing from the scope of the disclosure. It is therefore intended that all such variations be included within the scope of the following claims and their equivalents.

What is claimed is:

1. A method comprising:
receiving, by a processing device, a plurality of activities of a user on a webpage of a web site posting of a vehicle;
determining, by the processing device, an interest level of the user for the web site posting of the vehicle in view of the plurality of activities of the user;
receiving, by the processing device, an indication of a change of a status of the web site posting of the vehicle; and
providing to the user, by the processing device, a notification of the change of the status of the web site posting of the vehicle in view of the interest level of the user, and in response to the indication of the change of the status of the web site posting of the vehicle.

2. The method of claim 1, further comprising:
determining, by the processing device, if the plurality of activities of the user on the webpage meets a predetermined threshold; and
providing to the user, by the processing device, the notification of the change of the status of the web site posting of the vehicle in response to a determination that the plurality of activities of the user on the webpage meets the predetermined threshold.

3. The method of claim 2, wherein determining the interest level of the user for the web site posting of the vehicle further comprises:
assigning, by the processing device, each of the plurality of activities of the user a respective value;
calculating, by the processing device, a sum of each respective value; and
determining, by the processing device, if the sum meets the predetermined threshold.

4. The method of claim 1, further comprising:
receiving, by the processing device, a request for a web site membership from the user after the user has viewed the web site posting of the vehicle; and
providing to the user, by the processing device, the notification of the change of the status of the web site posting of the vehicle in response to the request for the web site membership from the user.

5. The method of claim 1, further comprising:
determining, by the processing device, details of the web site posting of the vehicle;
determining, by the processing device, a web site posting of a different vehicle in view of the details of the web site posting of the vehicle;
determining, by the processing device, a change of a status of the web site posting of the different vehicle, in view of the details of the web site posting of the vehicle; and
providing to the user, by the processing device, an additional notification of the change of the status of the web site posting of the different vehicle.

6. The method of claim 5, wherein the details of the web site posting of the vehicle comprises at least one of a price of the vehicle, a manufacturer of the vehicle, a model of the vehicle, a year of the vehicle, a mileage of the vehicle, a location of the vehicle, or a color of the vehicle.

7. The method of claim 1, further comprising:
providing to the user, by the processing device, a message indicating a number of other users that also receive the notification of the change of the status of the web site posting of the vehicle.

8. The method of claim 1, wherein the change of the status of the web site posting of the vehicle is at least one of a change in price of the vehicle, a change in availability of the vehicle, a change in location of the vehicle, or a change in an attribute of the vehicle.

9. The method of claim 1, wherein an activity of the user on the webpage of the web site posting of the vehicle is at least one of a user click on the web site posting of the vehicle, a user view of pictures of the web site posting of the vehicle, a user contact of a dealer of the vehicle, or a user view of a vehicle history report of the vehicle.

10. A system comprising:
a memory; and
a processing device communicably coupled to the memory, the processing device to:
receive a plurality of activities of a user on a webpage of a web site posting of a vehicle;
determine an interest level of the user for the web site posting of the vehicle in view of the plurality of activities of the user;
receive an indication of a change of a status of the web site posting of the vehicle; and
provide a notification of the change of the status of the web site posting of the vehicle in view of the interest level of the user, and in response to the indication of the change of the status of the web site posting of the vehicle.

11. The system of claim 10, further comprising:
determine if the plurality of activities of the user on the webpage meets a predetermined threshold; and
provide to the user the notification of the change of the status of the web site posting of the vehicle in response to a determination that the plurality of activities of the user on the webpage meets the predetermined threshold.

12. The system of claim 11, wherein determine the interest level of the user for the web site posting of the vehicle further comprises:
assign each of the plurality of activities of the user a respective value;
calculate a sum of each respective value; and
determine if the sum value meets the predetermined threshold.

13. The system of claim 10, further comprising:
receive a request for a web site membership from the user after the user has viewed the web site posting of the vehicle; and
provide to the user the notification of the change of the status of the web site posting of the vehicle in response to the request for the web site membership from the user.

14. The system of claim 10, further comprising:
determine details of the web site posting of the vehicle;
determine a web site posting of a different vehicle in view of the details of the web site posting of the vehicle;
determine a change of a status of the web site posting of the different vehicle, in view of the details of the web site posting of the vehicle; and
provide to the user an additional notification of the change of the status of the web site posting of the different vehicle.

15. The system of claim 14, wherein the details of the web site posting of the vehicle comprises at least one of a price of the vehicle, a manufacturer of the vehicle, a model of the vehicle, a year of the vehicle, a mileage of the vehicle, a location of the vehicle, or a color of the vehicle.

16. A non-transitory computer readable storage medium including instructions that, when executed by a processing device, cause the processing device to execute operations comprising:
receiving, by a processing device, a plurality of activities of a user on a webpage of a web site posting of a vehicle;
determining, by the processing device, an interest level of the user for the web site posting of the vehicle in view of the plurality of activities of the user;
receiving, by the processing device, an indication of a change of a status of the web site posting of the vehicle; and
providing to the user, by the processing device, a notification of the change of the status of the web site posting of the vehicle in view of the interest level of the user, and in response to the indication of the change of the status of the web site posting of the vehicle.

17. The non-transitory computer readable storage medium of claim 16, further comprising:
determining, by the processing device, if the plurality of activities of the user on the webpage meets a predetermined threshold; and
providing to the user, by the processing device, the notification of the change of the status of the web site posting of the vehicle in response to a determination that the plurality of activities of the user on the webpage meets the predetermined threshold.

18. The non-transitory computer readable storage medium of claim 17, wherein determining the interest level of the user for the web site posting of the vehicle further comprises:
assigning, by the processing device, each of the plurality of activities of the user a respective value;
calculating, by the processing device, a sum of each respective value; and
determining, by the processing device, if the sum meets the predetermined threshold.

19. The non-transitory computer readable storage medium of claim 16, further comprising:
receiving, by the processing device, a request for a web site membership from the user after the user has viewed the web site posting of the vehicle; and
providing to the user, by the processing device, the notification of the change of the status of the web site posting of the vehicle in response to the request for the web site membership from the user.

20. The non-transitory computer readable storage medium of claim 16, further comprising:
determining, by the processing device, details of the web site posting of the vehicle;
determining, by the processing device, a web site posting of a different vehicle in view of the details of the web site posting of the vehicle;
determining, by the processing device, a change of a status of the web site posting of the different vehicle, in view of the details of the web site posting of the vehicle; and
providing to the user, by the processing device, an additional notification of the change of the status of the web site posting of the different vehicle.
